(19) United States
(12) Patent Application Publication
(10) Pub. No.: US 2025/0149563 A1
(43) Pub. Date: May 8, 2025

(54) NEGATIVE ELECTRODE FOR A LITHIUM SECONDARY BATTERY AND A LITHIUM SECONDARY BATTERY INCLUDING THE SAME

(71) Applicant: LG ENERGY SOLUTION, LTD., Seoul (KR)

(72) Inventors: Jong Yoon LEE, Daejeon (KR); Sukhyun HONG, Daejeon (KR); Suenghoon HAN, Daejeon (KR); Kyungsik HONG, Daejeon (KR); Jaekyo NOH, Daejeon (KR); Hyeon Jin KIM, Daejeon (KR)

(21) Appl. No.: 18/833,877

(22) PCT Filed: Nov. 23, 2023
(86) PCT No.: PCT/KR2023/018950

§ 371 Date: Jul. 26, 2024

(30) Foreign Application Priority Data
Dec. 15, 2022 (KR) 10-2022-0176315

(51) Int. Cl. H01M 4/38; H01M 4/02; H01M 4/134; H01M 10/052

(52) U.S. Cl. CPC H01M 4/382; H01M 4/134; H01M 10/052; H01M 2004/021; H01M 2004/027

(57) ABSTRACT

The present disclosure relates to a negative electrode for a lithium secondary battery and a lithium secondary battery including the same. The negative electrode for the lithium secondary battery includes: a first layer including a first lithium metal sheet; a second layer formed on a top surface of the first layer and including a second lithium metal sheet and a negative electrode collector surrounding an outer peripheral surface of the second lithium metal sheet; and a third layer formed on a top surface of the second layer and including a third lithium metal sheet.

### CROSS-REFERENCE TO RELATED APPLICATIONS

The present application is a National Phase entry pursuant to 35 U.S.C. § 371 of International Application No. PCT/KR2023/018950, filed on Nov. 23, 2023, and claims priority to and benefit of Korean Patent Application No. 10-2022-0176315, filed Dec. 15, 2022, the entire contents of which are incorporated herein by reference for all purposes as if fully set forth herein.

### TECHNICAL FIELD

The present disclosure relates to a negative electrode for a lithium secondary battery and a lithium secondary battery comprising the same.

### BACKGROUND

With the rapid development of the electronics, communications, and computer industries, energy storage technology is expanding to camcorders, cell phones, laptops, PCs, and even electric vehicles. This has led to the development of high-performance secondary batteries that are lightweight, long-lasting, and highly reliable.

Lithium secondary batteries are gaining traction as batteries that meet these needs.

A lithium secondary battery having a laminated or wound structure of an electrode assembly includes a positive electrode and a negative electrode, and a separator interposed therebetween. The electrode assembly is embedded in a battery case and an electrolyte is injected therein. The lithium secondary battery produces electrical energy by an oxidation/reduction reaction when lithium ions are introduced/removed from a positive electrode and a negative electrode.

Among lithium secondary batteries, a lithium-sulfur battery, which uses sulfur-based materials as the positive-electrode active material, is a battery that has recently gained attention. Sulfur, the primary material for positive-electrode active materials, has the advantages of being very abundant, non-toxic, and having a low weight per atom. In addition, the theoretical discharge capacity of the Li-Sulfur battery is 1,675 mAh/g-sulfur, and the theoretical energy density is 2,600 Wh/kg, which is higher than the theoretical energy density of other battery systems currently being studied (Ni-MH battery: 450 Wh/kg, Li—FeS battery: 480 Wh/kg, Li—MnO₂ battery: 1,000 Wh/kg, Na—S battery: 800 Wh/kg), making them the most promising batteries being developed to date.

FIG. 1 is a cross-sectional view of a conventional lithium secondary battery 100. Referring to FIG. 1, a separator 130 is interposed between a positive electrode 110 and a negative electrode 120, in which the size of the negative electrode 120 is larger than the size of the positive electrode 110, and the negative electrode 120 is located in a region that is aligned with the positive electrode 110, so that the negative electrode 120 and the positive electrode 110 are in contact with each other by way of the separator 130 interposed therebetween. Since the size of the negative electrode 120 is larger than the size of the positive electrode 110, there is an area A on the negative electrode 120 that is not in contact with the positive electrode 110. The negative electrode 120 may be made of lithium metal.

The charging and discharging reaction of the lithium secondary battery 100 takes place only in the region where the negative electrode 120 and the positive electrode 110 contact each other by way of the separator 130 interposed therebetween. When the charging and discharging reactions of the lithium secondary battery 100 are repeatedly performed, the porosity of the lithium metal that is the negative electrode 120 gradually increases, and the rigidity becomes weaker. Accordingly, the lithium metal can become detached in the area A that is not in contact with the positive electrode 110, which corresponds to the edges of the negative electrode 120. The detached lithium metal pieces may move freely inside the pouch cell, and when an external force is applied to the lithium secondary battery 100, the detached lithium metal pieces may cause a short circuit of the lithium secondary battery 100.

Therefore, there is a need for research on lithium secondary batteries that can solve the above problems.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### RELATED ART

Korean Laid-Open Publication No. 100-2017-0124075

### SUMMARY

In order to solve the above problem, the present inventors conducted various studies and confirmed that, by changing the structure of the negative electrode for a lithium secondary battery, it is possible to prevent the lithium metal from being detached in the area of the negative electrode that is not in contact with the positive electrode by way of a separator, and completed embodiments of the present disclosure.

Accordingly, in certain embodiments, it is an object of the present disclosure to provide a negative electrode for a lithium secondary battery capable of exhibiting little or no detachment of lithium metal.

Further, in certain embodiments, it is an object of the present disclosure to provide a lithium secondary battery comprising such a negative electrode for the lithium secondary battery.

To achieve the above objectives, according to certain aspects, the present disclosure provides a negative electrode for a lithium secondary battery, including: a first layer including a first lithium metal sheet; a second layer formed on a top surface of the first layer and including a second lithium metal sheet and a negative electrode collector surrounding an outer peripheral surface of the second lithium metal sheet; and a third layer formed on a top surface of the second layer and including a third lithium metal sheet.

In an embodiment of the present disclosure, the negative electrode collector may have same or different edge widths in vertical and horizontal directions as viewed from a top, bottom, left or right direction.

In an embodiment of the present disclosure, the negative electrode collector may have a surface area of from 10 to 30% of a surface area of the second layer, as viewed from a top direction.

In an embodiment of the present disclosure, a lower surface of the negative electrode collector that abuts the lithium metal sheet of the first layer, and an upper surface of the negative electrode collector that abuts the third lithium metal sheet of the third layer, may comprise undulated structures.

In an embodiment of the present disclosure, the negative electrode collector may have a thickness of 1 to 10 μm in a vertical direction.

In an embodiment of the present disclosure, the negative electrode collector may have a thickness of 1 or more and less than 5 μm in the vertical direction.

In an embodiment of the present disclosure, the first and third layers may have a same size.

In an embodiment of the present disclosure, a thickness of the negative electrode collector and a thickness of the lithium metal sheet of the second layer may be the same in the vertical direction.

In an embodiment of the present disclosure, the first layer may have a thickness of 10 to 50 μm, the third layer may have a thickness of 10 to 50 μm, and the negative electrode for a lithium secondary battery may have a thickness of 21 to 110 μm, in the vertical direction.

In an embodiment of the present disclosure, the negative electrode for the lithium secondary battery may be a negative electrode for a lithium-sulfur battery.

Embodiments of the present disclosure also provide a lithium secondary battery, including: a positive electrode; a negative electrode; a separator interposed between the positive and negative electrodes; and an electrolyte, wherein a size of the negative electrode is larger than a size of the positive electrode, as viewed from a top direction, and wherein the negative electrode is the aforementioned negative electrode.

In an embodiment of the present disclosure, a size of the lithium metal sheet of the second layer of the negative electrode may be less than or equal to the size of the positive electrode, as viewed in the top direction.

In an embodiment of the present disclosure, the lithium secondary battery may be a lithium-sulfur battery.

According to aspects of the present disclosure, the negative electrode for the lithium secondary battery can exhibit reduced or even no detachment of the lithium metal from the area that is not in contact with the positive electrode by way of the separator interposed therebetween, and may thereby minimize the loss of energy density, and improve safety.

### BRIEF DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a cross-sectional view of a conventional lithium secondary battery.

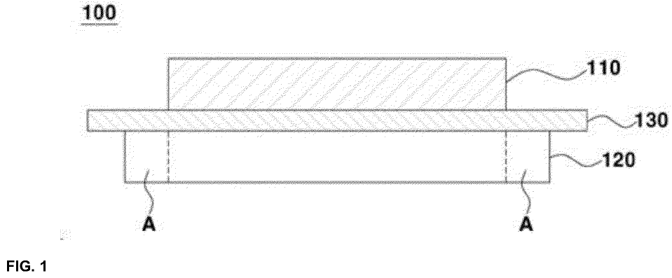

FIG. 2 is a side view of a negative electrode for a lithium secondary battery according to an embodiment of the present disclosure.

FIG. 3 is a cross-sectional view of a negative electrode for a lithium secondary battery according to an embodiment of the present disclosure.

FIG. 4 is a top view of a second layer of a negative electrode for a lithium secondary battery, according to an embodiment of the present disclosure.

FIG. 5 is a cross-sectional view of a lithium secondary battery according to an embodiment of the present disclosure.

### DETAILED DESCRIPTION

Embodiments of the present disclosure are hereinafter described in detail with reference to the accompanying drawings so as to facilitate practice by one having ordinary skill in the art to which the present disclosure belongs. However, embodiments of the present disclosure may be implemented in many different forms and are not limited to the embodiments described herein.

In order to clearly illustrate aspects of the present disclosure, parts not pertinent to the description have been omitted, and identical or similar components are designated by the same reference numerals throughout the specification.

Furthermore, the terms and words used in this specification and the claims are not necessarily to be construed in their ordinary or dictionary sense, but are to be construed according to the meaning and concepts consistent with the technical ideas disclosed herein, and based on the principle that the inventor may be their own lexicographer to properly define the terms used to describe their invention.

Hereinafter, embodiments will be described in detail with reference to the accompanying drawings. However, the present disclosure can be implemented in many different forms and is not limited to the embodiments described herein.

Aspects of the present disclosure provide a negative electrode 120 for a lithium secondary battery, comprising: a first layer 121 comprising a first lithium metal sheet 132; a second layer 122 formed on a top surface 134 of the first layer and including a second lithium metal sheet 124 and a negative electrode collector 125 surrounding an outer peripheral surface 138 of the lithium metal sheet; and a third layer 123 formed on a top surface of the second layer and including a third lithium metal sheet 133.

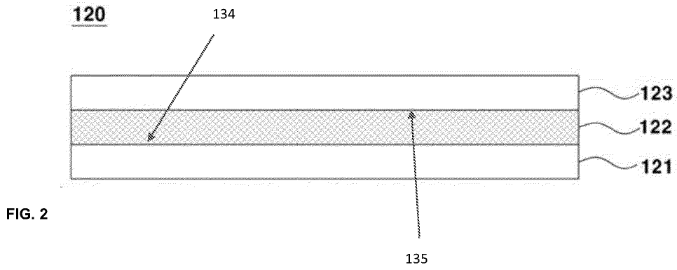

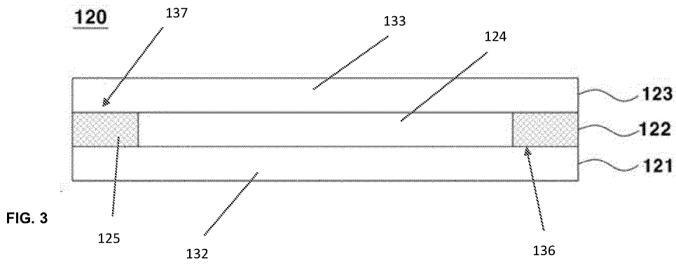

FIG. 2 is a side view of a negative electrode 120 for a lithium secondary battery according to an embodiment of the present disclosure, and FIG. 3 is a cross-sectional view of the negative electrode 120 for a lithium secondary battery according to an embodiment of the present disclosure.

Referring to FIGS. 2 and 3, the negative electrode 120 for a lithium secondary battery according to an embodiment of the present disclosure includes first to third layers 121, 122, 123, which are stacked from top to bottom.

According to certain aspects, the first layer 121 and the third layer 123 may each comprise a lithium metal sheet, and preferably each consist of a lithium metal sheet.

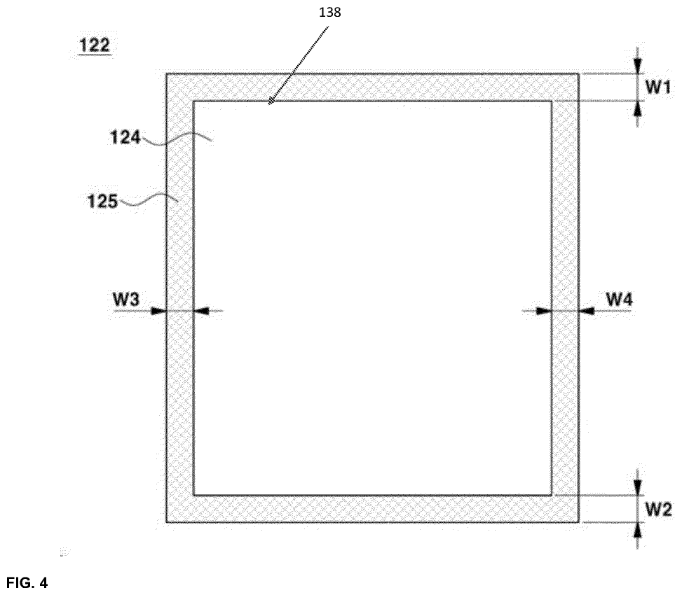

FIG. 4 is a top view of the second layer 122 of the negative electrode 120 for a lithium secondary battery, according to an embodiment of the present disclosure.

Referring to FIG. 4, according to certain embodiments, the second layer 122 may comprise the second lithium metal sheet 124 and a negative electrode collector 125 surrounding an outer peripheral surface 138 of the second lithium metal sheet 124. That is, the negative electrode collector 125 may be hollow in the center, with the second lithium metal sheet 124 located in the hollow space.

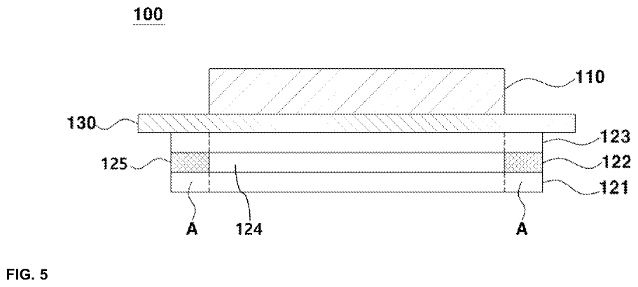

Therefore, referring to FIG. 2, in a side view of the negative electrode 120 for a lithium secondary battery according to an embodiment of the present disclosure, only the negative electrode collector 125 may be shown in the second layer 122, and, referring to FIG. 5, in a side view of the negative electrode 120 for a lithium secondary battery according to an embodiment of the present disclosure, both the negative electrode collector 125 and the second lithium metal sheet 124 may be shown in the second layer 122.

The area of the negative electrode collector 125 is present only on the outer peripheral surface 138 of the second lithium metal sheet 124, such that it is smaller than the area of the lithium metal sheet 124, and can preferably have a surface area of 10 to 30%, more preferably 10 to 20%, of the surface area of the second layer 122, as viewed from a top direction (e.g. a viewed from the top as in FIG. 4).

Furthermore, the negative electrode collector 125 may have the same or different edge widths in vertical and horizontal directions as viewed from a top, bottom, left or right direction. When the widths of collector in the vertical and horizontal directions of the negative electrode collector 125 are W1, W2, W3, and W4, respectively, they may be the same or different from each other, and are preferably defined by any of the following Equations 1 to 3.

$$W 1 = W 2 = W 3 = W 4 \qquad Equation l$$

$$W 1 \neq W 2 \neq W 3 \neq W 4 \qquad Equation 2$$

$$( W 1 = W 2 ) \neq ( W 3 = W 4 ) \qquad Equation 3$$

In the above Equations 1 to 3, and referring to the top view of FIG. 4, W1 is the vertical width of the upper edge, W2 is the vertical width of the lower edge, W3 is the horizontal width of the left edge, and W4 is the horizontal width of the right edge.

According to certain embodiments, preferably, the edge width of the negative electrode collector 125 may be as shown in Equation 1 above.

The thickness of the negative electrode collector 125 may be between 1 and 10 μm, preferably 1 μm or more and less than 5 μm, in the vertical direction (i.e. in the vertical direction as depicted in FIG. 3). According to certain embodiments, since a thickness of less than 1 μm is an excessively thin thickness, it may not be possible to fabricate a thickness of the negative electrode collector 125 of less than 1 μm, and a thickness of more than 10 μm may result in a heavy weight of the negative electrode 120 for the lithium secondary battery, thereby reducing the energy density of the lithium secondary battery 100.

According to certain embodiments, the vertical thickness of the second lithium metal sheet 124 and the negative electrode collector 125 forming the second layer 122 may be the same (i.e. in the vertical direction as depicted in FIG. 3). According to certain aspects, if the thickness of the second lithium metal sheet 124 is thinner than the thickness of the negative electrode collector 125, then the lithium metal sheets of the first layer 121 and the third layer 123 may only contact the negative electrode collector 125 of the second layer 122, and not the lithium metal sheet 124, creating a void. Therefore, in the lithium secondary battery 100 including the negative electrode 120, the negative electrode 120 may not contribute to the generation of the capacitance of the lithium secondary battery 100, and as a result, the overall energy density of the lithium secondary battery 100 may decrease. Additionally, if the thickness of the second lithium metal sheet 124 is thicker than the thickness of the negative electrode collector 125, the lithium metal sheets of the first layer 121 and the third layer 123 may only contact the second lithium metal sheet 124 of the second layer 122, and not the negative electrode collector 125, creating a void and potentially reducing the conductivity of the negative electrode collector 125.

According to certain embodiments, the fabrication of the second layer 122 may be accomplished by disposing a sheet of lithium metal on one or both sides of the negative electrode collector 125 and rolling it, although aspects of present disclosure are not limited thereto.

According to certain embodiments, the first to third layers 121, 122, 123 may be of the same size.

Furthermore, according to certain embodiments, the negative electrode collector 125 may comprise an undulated structure on a lower surface 136 that abuts the first lithium metal sheet 132 of the first layer 121, and an undulated structure on an upper surface 137 that abuts the third metal sheet of the third layer 123.

The undulation(s) may be formed regularly or irregularly, for example, the undulation may be formed in the form of polygonal columns protruding or retracted from the surface(s) of the negative electrode current collector. More specifically, the undulation(s) may be formed in the form of protruding or retracted serrations.

Specifically, according to certain embodiments, the lower surface of the negative electrode collector 125 contacts the top surface of the lithium metal sheet of the first layer 121, with the lower surface of the negative electrode collector 125 having an undulated structure. Furthermore, according to certain embodiments, the upper surface of the negative electrode collector 125 may be in contact with the bottom surface 135 of the lithium metal sheet of the third layer 123, with the top surface of the negative electrode collector 125 having an undulated structure. Also, since the second lithium metal sheet 124 of the second layer 122 is located on the inner side of the negative electrode collector 125, the inner circumferential surface of the negative electrode collector 125 in contact therewith may have an undulated structure.

According to certain embodiments, due to the undulated structure of the surface of the negative electrode current collector 125 that contacts the first and third lithium metal sheets 132, 133 of the first and third layers 121, 122, 123, it may be possible to increase the adhesion strength with the lithium metal sheets. Additionally, the undulated surface(s) can reduce the weight of the negative electrode 120 used in lithium secondary batteries.

The negative electrode collector 125 is not particularly limited as long as it has a high conductivity without causing chemical changes in the lithium secondary battery 100. For example, copper, stainless steel, aluminum, nickel, titanium, palladium, calcined carbon, copper or stainless steel which is surface treated with carbon, nickel, silver, etc., aluminum-cadmium alloys, and the like may be used.

The thickness of the first layer 121 may be from 10 to 50 μm, and the thickness of the third layer may be from 10 to 50 μm (the thickness is measured in the vertical direction, e.g. as shown in FIG. 3). Furthermore, the thickness of the negative electrode 120 for the lithium secondary battery, as measured in the vertical direction, may be 21 to 110 μm, preferably 21 μm or more and less than 105 μm.

According to certain embodiments, the negative electrode 120 for a lithium secondary battery may be fabricated by disposing the first layer 121 on the bottom surface of the second layer 122, disposing the third layer 123 on the upper surface of the second layer 122, and rolling the same, but the present disclosure is not particularly limited thereto. Alternatively, the negative electrode 120 for a lithium secondary battery may be fabricated by placing lithium metal sheets on both sides of the negative electrode collector 125 and rolling the same. According to this embodiment, the second lithium metal sheet 124 is introduced inside the negative electrode collector 125 to form the second layer 122, and the lithium metal sheets that cannot be introduced and remain are present on the upper and the lower surfaces of the second layer 122. The lithium metal sheet located on the bottom surface may be the first layer 121, and the lithium metal sheet located on the top surface may be the third layer 123.

The negative electrode 120 for a lithium secondary battery according to an embodiment of the present disclosure may be a negative electrode for a lithium-sulfur battery.

According to certain embodiments, the present disclosure is directed to a lithium secondary battery 100, comprising: a positive electrode 110; a negative electrode 120; and a separator 130 interposed between the positive and negative electrodes, wherein the size of the negative electrode 120 is larger than the size of the positive electrode 110 as viewed from the top direction (e.g. as viewed from the top direction as shown in FIG. 5), and the negative electrode 120 is the aforementioned negative electrode 120 according to an embodiment of the present disclosure.

FIG. 5 is a cross-sectional view of the lithium secondary battery 100 according to an embodiment of the present disclosure.

Referring to FIG. 5, the lithium secondary battery 100 according to embodiments of the present disclosure comprises the positive electrode 110, the negative electrode 120, and a separator interposed between the positive electrode 110 and the negative electrode 120.

The negative electrode 120 and the positive electrode 110 may be located at regions that are aligned with respect to each other.

Further, according to certain embodiments, since the size of the negative electrode 120 may be larger than the size of the positive electrode 110, the negative electrode 120 may have a region A that is not in contact with the positive electrode 110 and a region in contact with the positive electrode 110 by way of the separator. The region in contact with the positive electrode 110 means that the positive electrode 110 and the negative electrode 120 are not in direct contact, but are in contact with the separator 130 disposed therebetween.

Here, the size of the lithium metal sheet 124 of the second layer 122 of the negative electrode 120, as measured in the vertical direction, may be less than or equal to the size of the positive electrode 110.

According to certain embodiments, the positive electrode 110 may be a positive-electrode collector (not shown) to which a positive-electrode active material is provided, and in which the positive-electrode active material may comprise sulfur. Specifically, the sulfur may be at least one selected from a group consisting of inorganic sulfur (S₈), Li—Sₙ (n≥1), organic sulfur compounds, and carbon-sulfur polymers [(C₂Sₓ)ₙ, x=2.5 to 50, n≥2], and preferably inorganic sulfur (S₈). Further, the positive-electrode active material may be a sulfur-carbon composite which comprises porous carbon material and sulfur on at least some of the inner and outer surfaces of the porous carbon material.

Thus, the lithium secondary battery 100 according to an embodiment of the present disclosure may be a lithium-sulfur battery.

The lithium secondary battery 100 according to an embodiment of the present disclosure may solve the problem of detachment of lithium metal occurring in conventional lithium secondary batteries. In detail, the negative electrode 120 for a lithium secondary battery according to an embodiment of the present disclosure includes the second lithium metal sheet 124 and the negative electrode collector 125 surrounding an outer peripheral surface 138 of the second lithium metal sheet 124 in the second layer 122. In the conventional lithium secondary battery 100, the porosity of the lithium metal gradually increases when charging and discharging reactions are repeatedly performed, and as the stiffness weakens, the detachment of the lithium metal proceeds from the edge of the negative electrode 120, that is, the region (A) where the negative electrode 120 does not contact the positive electrode 110. The negative electrode 120 for the lithium secondary battery according to an embodiment of the present disclosure, on the other hand, includes the negative electrode collector 125 in the second layer 122, and the detachment of the lithium metal can be prevented by the negative electrode collector 125 even if the rigidity of the lithium metal becomes weaker with repeated charging and discharging. Thus, the lithium secondary battery 100 according to an embodiment of the present disclosure can minimize the loss of energy density while securing safety. Due to repeated charging and discharging, detachment of lithium metal may occur at the edges of the first layer 121 and the third layer 123 of the negative electrode 120 for the lithium secondary battery, but due to the negative electrode collector 125 of the second layer 122, the bonding between the lithium metal sheets of the first and third layers can be maintained, thereby solving the same problem as in the prior art.

On the other hand, in the case of a negative electrode having lithium metal sheets laminated to the entire area of the sheet-shaped negative electrode collector, the weight is heavy and may cause a loss of energy density of the lithium secondary battery. Furthermore, in the case of the negative electrode comprising solely the second layer 122 of the present disclosure, the thickness of the second layer 122 of the present disclosure may be required to be thicker than the thickness of the second layer 122 of the present disclosure because only the second layer 122 is required to be used as a negative electrode, and therefore, the weight may be heavier than the negative electrode 120 for the lithium secondary battery of the present disclosure. Therefore, the negative electrode 120 for the lithium secondary battery according to an embodiment of the present disclosure may be more advantageous in terms of energy density.

While the above has described in detail a preferred embodiment of the present disclosure, the scope of the present disclosure is not limited thereto, and various modifications and improvements by those skilled in the art utilizing the basic concepts of the present disclosure as defined in the following claims are also within the scope of the present i disclosure.

### EXPLANATION OF REFERENCE NUMERALS

| | |
|---|---|
| 100: Lithium secondary battery | 110: Positive electrode |
| 120: Negative electrode | 121: First layer |
| 122: Second layer | 123: Third layer |
| 124: Second Lithium metal sheet | 125: Negative electrode |
| | collector |
| 130: Separator | |
| 132: First Lithium metal sheet | |
| 133: Third Lithium metal sheet | |
| 134: Top surface of the first layer | |
| 135: Bottom surface of the third layer | |
| 136: Lower surface of the negative electrode | |
| collector | |
| 137: Upper surface of the negative electrode | |
| collector | |
| 138: Outer peripheral surface of the second | |
| lithium metal sheet | |

1. A negative electrode for a lithium secondary battery, comprising:
a first layer comprising a first lithium metal sheet;
a second layer formed on a top surface of the first layer and including a second lithium metal sheet and a negative electrode collector surrounding an outer peripheral surface of the second lithium metal sheet; and
a third layer formed on a top surface of the second layer and including a third lithium metal sheet.

2. The negative electrode for the lithium secondary battery according to claim 1, wherein the negative electrode collector has the same or different edge widths in vertical and horizontal directions as viewed from a top, bottom, left or right direction.

3. The negative electrode for the lithium secondary battery according to claim 1, wherein the negative electrode collector has a surface area of from 10 to 30% of a surface area of the second layer, as viewed from a top direction.

4. The negative electrode for the lithium secondary battery according to claim 1, wherein a lower surface of the negative electrode collector that abuts the first lithium metal sheet of the first layer, and an upper surface of the negative electrode collector that abuts the third lithium metal sheet of the third layer, comprise undulated structures.

5. The negative electrode for the lithium secondary battery according to claim 1, wherein the negative electrode collector has a thickness of 1 to 10 μm in a vertical direction.

6. The negative electrode for the lithium secondary battery according to claim 5, wherein the negative electrode collector has a thickness of 1 or more and less than 5 μm in the vertical direction.

7. The negative electrode for the lithium secondary battery according to claim 1, wherein the first and third layers have a same size.

8. The negative electrode for the lithium secondary battery according to claim 1, wherein a thickness of the negative electrode collector and a thickness of the lithium metal sheet of the second layer are same in a vertical direction.

9. The negative electrode for the lithium secondary battery according to claim 1, wherein the first layer has a thickness of 10 to 50 μm, the third layer has a thickness of 10 to 50 μm, and the negative electrode for a lithium secondary battery has a thickness of 21 to 110 μm, in a vertical direction.

10. The negative electrode for the lithium secondary battery according to claim 1, wherein the negative electrode is for a lithium-sulfur battery.

11. A lithium secondary battery, comprising:
a positive electrode;
a negative electrode;
a separator interposed between the positive and negative electrodes; and an electrolyte,
wherein a size of the negative electrode is larger than a size of the positive electrode, as viewed from a top direction; and
wherein the negative electrode is the negative electrode of claim 1.

12. The lithium secondary battery according to claim 11, wherein a size of the lithium metal sheet of the second layer of the negative electrode is less than or equal to the size of the positive electrode, as viewed from the top direction.

13. The lithium secondary battery according to claim 11, wherein the lithium secondary battery is a lithium-sulfur battery.
